(19) United States
(12) Patent Application Publication
(10) Pub. No.: US 2007/0208483 A1
(43) Pub. Date: Sep. 6, 2007

(54) Safety control system for electric vehicle

(76) Inventor: Amihud Rabin, Tel Aviv (IL)

Correspondence Address: DEKEL PATENT LTD., DAVID KLEIN, BEIT HAROF'IM, 18 MENUHA VENAHALA STREET, ROOM 27, REHOVOT, 76209, omitted

(21) Appl. No.: 11/507,491

(22) Filed: Aug. 22, 2006

(30) Foreign Application Priority Data
Mar. 2, 2006 (IL) 174061

(51) Int. Cl. G05D 1/00

(52) U.S. Cl. 701/72; 701/93; 701/1

(57) ABSTRACT

A method of controlling a motorized vehicle including monitoring a movement characteristic and a stability criterion of a vehicle, sensing a change in the movement characteristic of the vehicle, and if the stability criterion and the change in the movement characteristic are above respective predefined values, causing a change in the velocity of the vehicle so that the stability criterion is no longer above the predefined value. Alternatively, an indication may be made to a rider of the vehicle if the stability criterion and the change in the movement characteristic are above respective predefined values, so that the rider can take action to stabilize the vehicle.

### FIELD OF THE INVENTION

This invention relates to automated safety control system for electric vehicles, in particular to systems controlling the speed of a vehicle.

### BACKGROUND OF THE INVENTION

U.S. Pat. No. 6,491,122 describes an electric scooter that has a propulsion system switchable between two modes, one of which allows a higher maximum speed than the other. The mode is selected by a user operated button. A steering angle sensor and a tilt switch are provided, which prevent the user from selecting the high-speed mode while steering sharply or while going down or across steep slopes. The output from the steering angle sensor is fed to a controller, which may impose on the propulsion system a limit on the low-speed mode that decreases progressively as the turn angle increases. The intent is to provide a higher speed for the vehicle when traveling on relatively flat ground and in a relatively straight line, without creating a possible unstable operation during turning, or on an inclined surface.

EP 0321676 describes an electrically propelled vehicle designed as a three-wheeled scooter. The scooter has an angular position detector on the steerable front wheel, which measures its position relative to the chassis. The output signal from the angular position detector is fed to a drive controller, so that the driving speed is reduced as the steering angle increases.

U.S. Pat. No. 6,615,937 describes a motorized wheelchair with individually driven left and right wheels, which is steered by a joystick for inputting speed and turn commands. The wheelchair is provided with a rate-of-turn feedback sensor and with forward/reverse motion, lateral motion, and vertical motion acceleration feedback sensors that are integrated into a closed-loop servo control system to differentially control the opposed wheels. Improved wheelchair motion stability is obtained through reduction/elimination of likely wheelchair spin-out and wheelchair tipping during wheelchair operation.

### SUMMARY OF THE INVENTION

In this application, the following terms will be used:

Maneuver (of the vehicle)—any change in uniform rectilinear or circular motion of the vehicle;

Steering system—means for changing the direction of motion of the vehicle. The steering system may be controlled directly by the user, or indirectly via a controller;

Steering parameter θ—a parameter characterizing the operational condition (status) of the steering system. It is assumed that θ=0 provides rectilinear motion of the vehicle. The parameter θ may be literally the angle of turning a scooter's tiller, or of a steering wheel, or of front wheels of a car. However, θ may be understood also as a difference between rotational speeds of left and right driving wheels, if they are powered and controlled independently.

There is thus provided in accordance with an embodiment of the invention a method of controlling a motorized vehicle including monitoring a movement characteristic (such as but not limited to, velocity) and a stability criterion of a vehicle, sensing a change in the movement characteristic of the vehicle, and if the stability criterion and the change in the movement characteristic are above respective predefined values, causing a change in the velocity of the vehicle (e.g., by decreasing a magnitude of the velocity of the vehicle and/or by changing a direction of the vehicle) so that the stability criterion is no longer above the predefined value.

In accordance with an embodiment of the present invention, there is provided a method of controlling a motorized vehicle steered by a human user, the vehicle comprising an electrical propulsion system controlled by a computerized controller, and a steering system. The user provides a vehicle speed command to the computerized controller for achieving a desired vehicle speed, and a steering command to the steering system. The method includes periodically measuring and/or calculating values of a set of physical variables including at least one variable characteristic of a maneuver of the vehicle and/or an external condition; storing said values so that one set of current values and at least one set of past values of the physical variables are available; calculating a predicted future stability condition of the vehicle using the current and past values, and time-dependent equations of motion for the vehicle; comparing the predicted condition to a predetermined safety criterion; and if the safety criterion is met, then controlling the speed of the propulsion system to achieve a vehicle speed according to the vehicle speed command; or if the safety criterion is not met, then controlling the speed of the propulsion system to achieve a safety vehicle speed such that the safety criterion is met.

The safety vehicle speed may be calculated by reverse solving the equations of motion using the safety criterion as a condition. The set of physical variables may include vehicle speed. The physical variable characteristic of a maneuver may be the lateral acceleration of the vehicle and/or vehicle's turning rate. The set of variables may further include lateral slope angle of the terrain and/or forward slope angle of the terrain. The vehicle speed may be measured and/or calculated using one or more of the following:

measurement of electrical current and/or voltage of the propulsion system;

measurement of rotational speed of a motor used in the propulsion system;

measurement of rotational speed of a wheel of the vehicle;

measurement of vehicle's body speed relative to the terrain.

In one embodiment, the method is used with a mechanical steering system with operative status characterized by a steering parameter (angle) θ where the steering command is a change Δθ of the steering parameter θ imposed by the user independently of the computerized controller. The set of variables may further include the steering parameter θ and the imposed change Δθ.

In another embodiment, the method is used with a steering system controlled by the computerized controller, where the steering command is a selected change AO of the steering parameter θ, provided to the controller by a suitable user interface. The set of variables may further include the steering parameter θ and the steering command Δθ.

If the safety criterion is met, the steering system may be controlled to fulfill the steering command. If the safety criterion is not met, both the speed of the propulsion system and the steering parameter θ may be controlled to achieve a safety vehicle speed and a safety steering parameter so that the safety criterion is met.

The method may be used with a propulsion system including independently driven left and right wheels of the vehicle and a steering system including means for individual control over rotational speeds of the left and right wheels. The steering parameter θ in this case is achieved by controlling the rotational speeds via the computerized controller.

Alternatively, the method may be used with a steering system including a servo drive for turning wheels of the motorized vehicle. In this case the steering parameter (angle) θ is achieved by controlling the servo drive via the computerized controller.

In any embodiment of the method, when the safety criterion is not met, and the speed of the propulsion system is controlled to achieve safety vehicle speed and safety steering parameter so that the safety criterion is met, the control may impose a condition of substantially uniform deceleration of the vehicle.

The method may also include an initial step of programming the computerized controller with data characterizing the vehicle or/and the user as a solid body.

According to another aspect of the present invention, there is provided a control system for controlling a motorized vehicle steered by a human user, the vehicle having an electrical propulsion system controlled by a computerized controller, and a steering system. The user provides a vehicle speed command to the computerized controller for achieving a desired vehicle speed, and a steering command to the steering system. The control system may include sensors for periodically measuring and/or means for calculating values of a set of physical variables including at least one variable characteristic of a maneuver of the vehicle and/or an external condition; memory means for storing the values so that a set of current values and at least one set of past values of the physical variables are available; computer means for calculating a predicted future stability condition of the vehicle using the current and the past values and the vehicle's equations of motion; computer means for comparing the predicted condition to a predetermined safety criterion; and safety control means adapted, if the safety criterion is not met, to generate a safety vehicle speed command and to override the vehicle speed command such that the safety criterion is met.

The system may include sensors for periodically measuring and/or means for calculating current values of vehicle's speed. These sensors may include one or more of the following: electric current and/or voltage sensor for the propulsion system; rotational speed sensor engaged with a motor of the propulsion system; rotational speed sensor engaged with a wheel of the vehicle; vehicle ground speed sensor. The system may include among the sensors a lateral accelerometer or/and a sensor for measuring vehicle's turning rate. The system may further include a sensor for measuring lateral slope angle of the terrain and/or a sensor for measuring forward slope angle of the terrain.

In one embodiment, the control system is used with a mechanical steering system characterized by a steering parameter (angle) θ, which steering system is adapted for changing the steering angle θ by a steering command (change Δθ) imposed by the user directly and independently of the computerized controller. The control system may include a sensor for measuring the steering angle θ or the change Δθ.

In another embodiment of the control system, the computerized controller is adapted to control the steering parameter θ, and the control system has a suitable user interface for inputting the steering command (change Δθ) into the computerized controller. The interface may be for example a joystick, a head movement sensor or a tiller sensor. The sensors may include a sensor for measuring the steering parameter θ. In this embodiment, the safety control means may be adapted, if the safety criterion is not met, to generate a combined safety speed and safety steering command and to override also the user's steering command such that the safety criterion is met.

In one case, the propulsion system may include independently driven left and right wheels of the vehicle, while the steering system includes means for individual control over rotational speeds of the left and right wheels. The computerized controller is adapted to maintain the steering parameter θ by controlling the rotational speeds.

In another case, the steering system may include a servo drive for turning wheels of the motorized vehicle. The computerized controller is then adapted to maintain the steering parameter (angle) θ by controlling the servo drive.

In all embodiments, the control system may include means for programming the computerized controller with data characterizing the vehicle and/or the human user as a solid body.

In one embodiment of the invention, the system may indicate to a rider of the vehicle if the stability criterion and the change in the movement characteristic are above respective predefined values, so that the rider can take action to stabilize the vehicle. For example, the control system may further comprise warning means for informing the user about detecting a predicted critical condition and/or about overriding a vehicle speed or steering command, for example, a visual, audio or vibration signal. The control system may also comprise means for calculation of a safe margin for changing the steering parameter θ depending on current values of the physical variables including current vehicle speed, and an indicator means for informing the user about that safe margin. For example, an array of switchable light emitting/reflecting elements may be suitably disposed in the user's field of vision.

Conditions in which stability of the vehicle might be lost depend on variables such as speed, terrain inclination, etc. Also the rate at which instability is approached is sensitive to these variables.

Attempts to prevent instability occurrence are much more effective when the controller is using the prediction method of the present invention. Without prediction of future conditions, the vehicle is handicapped compared to a vehicle using the controlled-predictor in one of the following ways:

The vehicle will lose control more often;

The controller will use higher safety margins for limiting the speed (or turning angle), causing the vehicle to be sluggish.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 is a four-wheeled golf car controlled by the method of the present invention;

FIG. 2 is a schematic illustration of speed/power control of the golf car in FIG. 1;

FIG. 3 is a scheme of input data flow in the controller-predictor of the present invention;

FIG. 4 is a scheme of transverse forces acting on the golf car of FIG. 1.

FIG. 5 is a three-wheeled scooter controlled by the method of the present invention;

FIG. 6 is a schematic illustration of speed/power control of the three-wheeled scooter in FIG. 5;

FIG. 7 is an electric wheelchair controlled by the method of the present invention;

FIG. 8 is a schematic illustration of speed/power control of the electric wheelchair in FIG. 7;

FIG. 9 is a scheme of input data flow in the controller-predictor of the wheelchair in FIG. 7;

FIG. 10 is an electric car with electro-mechanical steering controlled by the method of the present invention;

FIG. 11 is a schematic illustration of speed/power control of the electric car in FIG. 10; and

FIG. 12 is a scheme of transverse accelerations acting on the golf car of FIG. 1.

### DETAILED DESCRIPTION OF THE EMBODIMENTS

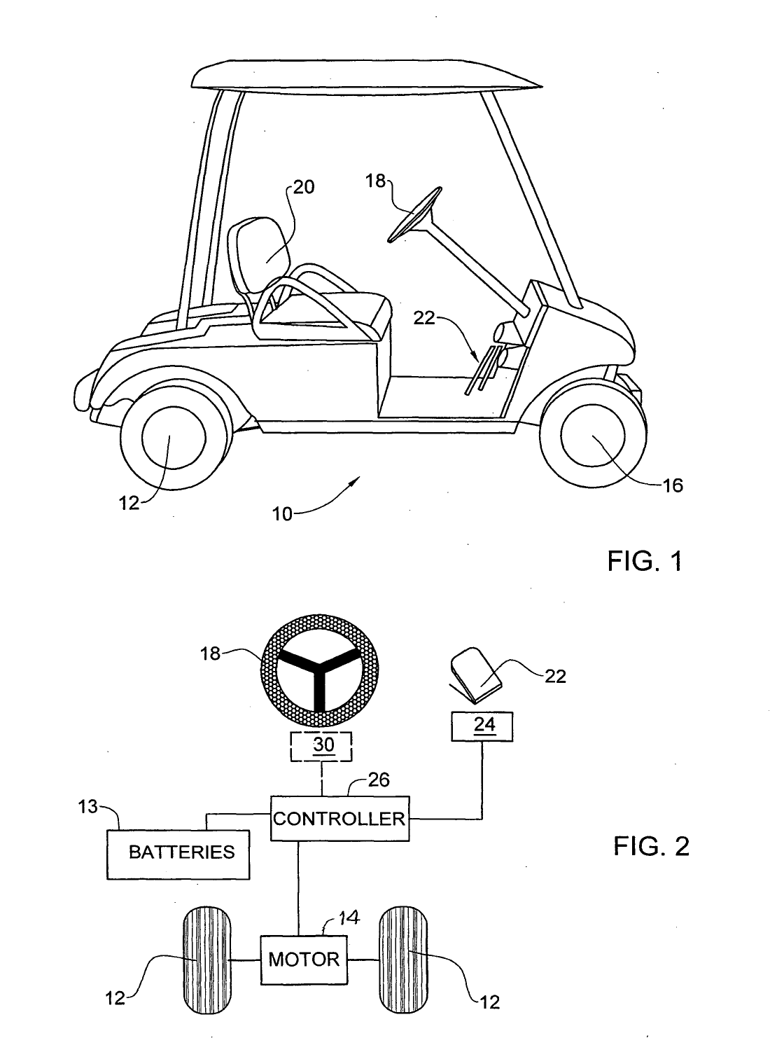

With reference to FIGS. 1 and 2, there is shown a 4-wheeled golf car 10 as an example of electric motor vehicle with mechanical steering. The car 10 has a pair of rear wheels 12 driven by a motor drive 14 (shown in FIG. 2) and a pair of front wheels 16 that can be manually steered by means of a steering wheel 18. The motor drive 14 drives rear wheels 12 through a differential (not shown), to allow the wheels 12 to rotate at different speeds on curves. The motor drive 14 may include reduction gearing or the like, to reduce the speed of rotation of the actual electric motor to that of the wheels 12. The electric motor can be a simple motor, for example, a DC brush permanent magnet motor or an AC or DC brushless motor.

The user sits on seat 20 and steers the vehicle 10 by means of the steering wheel 18. By turning the wheel 18, the user directly turns the front wheels 16. The user controls the speed of the vehicle 10 by means of a pedal 22, which is pivotally mounted on the vehicle floor under the steering wheel shaft. The pedal 22 is equipped with a sensor 24, which detects how far the pedal is moved. The further the pedal 22 is pressed towards the floor, the faster the selected speed. A selected speed signal (vehicle speed command) generated by the sensor 24 is conveyed to a controller 26, which controls the electric motor to achieve the selected speed.

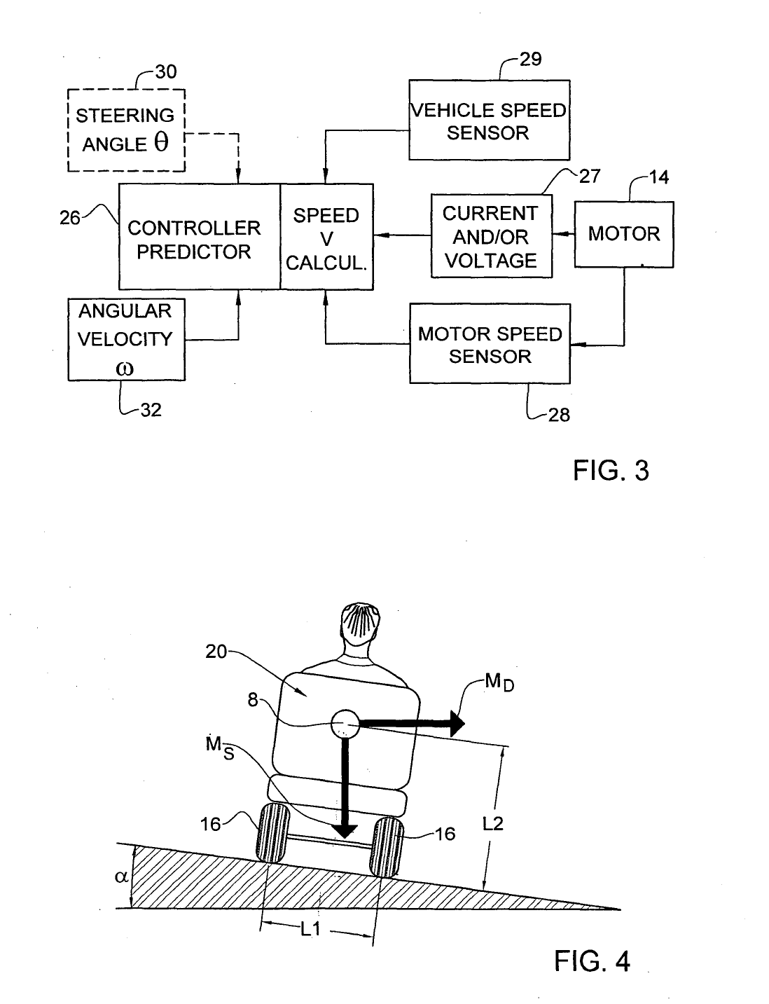

With reference also to FIG. 3, the controller 26 is a servo controller with capability of real time calculations. The controller 26 periodically measures the motor drive speed either by sensing the electric motor current and/or voltage 27, or by receiving speed indication signals from a rotational speed sensor 28 such as a tachometer, encoder, etc.

The controller 26 computes the vehicle speed from the motor drive speed and known gearing ratio. It is also possible to obtain the vehicle speed by sensing the rotational speed of other revolving parts of the vehicle such as wheels 12, for example, and feeding the signal 29 to the controller 26. The controller 26 may use the computed vehicle speed as feedback for achieving the selected vehicle speed.

The control system of the present invention may also include at least one sensor responsive to a maneuver of the mechanically steered vehicle 10, e.g., an angular velocity sensor 32 that measures the rate of turn of the vehicle 10. It may take for example the form of a gyroscope.

As mentioned above, in one embodiment of the invention, the system may indicate to a rider of the vehicle if the stability criterion and the change in the movement characteristic are above respective predefined values, so that the rider can take action to stabilize the vehicle. For example, the control system may further comprise warning means (which may be incorporated in controller 26, for example) for informing the user about detecting a predicted critical condition and/or about overriding a vehicle speed or steering command, for example, a visual, audio or vibration signal. In one embodiment, the control system of the invention may comprise a very simple construction. Any of the sensors described above or below or any combination thereof, such as velocity sensors, accelerometers and the like, may be used to sense if the vehicle's velocity or acceleration (or other parameter) is considered dangerous or threatening to the stability of the vehicle and the rider. This sensor may be in operational communication with the warning means (e.g., controller 26) to issue a warning to the rider. For example, if the sensor senses a dangerous or threatening parameter to the stability of the vehicle and the rider, the warning means may emit a loud audible warning (or a visible warning such as flashing lights). The rider may instantly react to the warning to slow down and or right the vehicle, without any need for non-human means (such as the control system) to slow down the vehicle.

Conditions in which the vehicle may lose control can develop in a very short time. Therefore, the controller samples the sensors periodically, in repeated short time intervals and calculates predicted values of the motion variables such as, for example, speed, angular turn velocity, lateral acceleration etc. for a close future moment, thus “looking ahead” in the vehicle behavior.

The predicted values are obtained using current values of the motion variables and the latest information about the rate of change of these variables, using equations of motion of the vehicle. As an example, the turn rate a) may be predicted:

$${ω}_{2} = {ω}_{1} + \frac{d ω}{d T} ( {T}_{2} - {T}_{1} )$$

where

ω₁—measured angular velocity at current time T₁.;

ω₂—predicted angular velocity at time T₂>T₁.;

dω/dT—current value of the rate of change of the angular velocity.

The rate of change of the angular velocity can be calculated in numerous ways out of the current and stored past measurements of the angular velocity. For example, linear extrapolation or polynomial extrapolation or any other suitable mathematical approximation may be used.

Once the controller has calculated the predicted values of the motion variables, they are used to calculate predicted forces and moments that will operate on the vehicle. The predicted forces and moments constitute a predicted condition of the vehicle which characterizes its behavior.

The control system has a stability criterion which is programmed in the controller and is used for assessment of the predicted condition. If the predicted condition does not meet the stability criterion, the vehicle is expected to lose stability or at least to start losing stability. Such a predicted condition is referred to as a critical condition. If the controller detects a critical predicted condition it will impose on the motor change of speed to a “safety speed”, and subsequently change of the vehicle speed to a safety vehicle speed, overriding the vehicle speed command set by the user. The safety vehicle speed may be calculated by the controller in real time for the current combination of motion variables and other given conditions, for example by reverse solving the equations of motion. Imposing the safety speed will stop or reverse the development of an out-of-control situation.

If the forces and moments conform to a predicted condition where the stability criterion is met, the controller will impose on the motor the vehicle speed command.

As shown in FIG. 4, the golf car of FIG. 1 will run out of control or lose stability (tip over) when the destabilizing moment M_{D} about the outer wheel is bigger than the stabilizing moment of gravity M_{S}:

M_{D}=(m·V·ω+m·g·sinα)L₂

$${M}_{S} = m \cdot g \cdot cos α \cdot \frac{{L}_{1}}{2}$$

where

V—measured or calculated vehicle speed;

ω—angular speed of vehicle;

m—mass of vehicle and passenger operating at center of gravity;

g—gravity acceleration;

α—lateral slope angle;

L₁—tread width; and

L₂—center of gravity height above a horizontal terrain

If the lateral slope angle is not available, the above calculation can be executed assuming α=0 or a negligible angle. In this way, the results will be less accurate but will still provide improved vehicle stability.

Thus the stability criterion in this case is M_{D}≦M_{S} while the critical predicted condition is M_{D}>M_{S}.

Similar improvement of stability can be achieved by using the above “look ahead” method with sensors measuring other physical parameters. Such sensor can be for example a lateral accelerometer. Increased lateral acceleration would indicate increase of destabilizing centrifugal force.

Another example is shown in broken lines in FIGS. 2 and 3. A sensor 30 may monitor the steering position of the front wheels 16 by measuring steering angle θ of the steering wheel 18 or by monitoring the position of some conveniently positioned part of the steering mechanism that is linked to the front wheels 16.

Increased steering angle will cause increased rate of turn of the vehicle. A vehicle response function of steering angle θ or of its increment Δθ may be previously programmed in the controller. For example, the turn rate response may be programmed as a function ω=ω(Δθ, T, V). The character and the coefficients of such functions may be determined by testing the vehicle on a set of values for steering angles and speeds and subsequent regression analysis, which technique is known per se in the art.

Further improvement of stability may be achieved by using additional slope sensors. Lateral slope angle can be measured by a lateral slope sensor, and also can be measured indirectly by using the readings of rate of turn sensor and lateral accelerometer. Centrifugal acceleration calculated from the rate of turn sensor may be compared to the readings of the lateral accelerometer to detect the gravity acceleration component on the accelerometer and thereby the slope angle. Lateral slope angle can also be measured indirectly by using the readings of vertical and lateral accelerometers.

Similar “look ahead” method of predicting future motion can use forward slope information to predict deteriorating stability when decelerating at high rates in downward slopes or accelerating at high rates in upward slopes. The forward slope angle can be measured by a forward/backward slope sensor, or can also be measured indirectly from the readings of vertical and forward/backward accelerometers. A forward slope angle can be used to predict deteriorating stability when decelerating at high rates during a turn. Then, the controller can control the vehicle speed to achieve acceleration or deceleration rates that will ensure stability.

The controller of the present invention may be programmable with data necessary for calculation of the equations of motion. The data may include, without limitation:

data characterizing the vehicle as manufactured, such as weight (mass), moments of inertia, CG location, tread width, wheel base, wheels diameter, etc.;

data characterizing the user and/or the payload, such as weight, moments of inertia, CG location, etc.; and

other coefficients (constants) of various functions describing vehicle's behavior and pertinent to solving the equations of motion.

Alternatively, some or all such data may be presented in the controller in averaged and non-changeable form.

The controller system described above may also be applied to other electric vehicles with mechanical steering, including 3-wheeled vehicles, such as all terrain vehicles, go-karts, club cars, passenger vehicles, electric push & pull add-on trolley motor drive systems, single front or rear add-on motor for manual steering for wheelchairs, electric trolley drive systems, electric drive fork truck lift and handheld fork lifts, children electric cars, electric three-wheeler rickshaw, urban electric vehicles, etc.

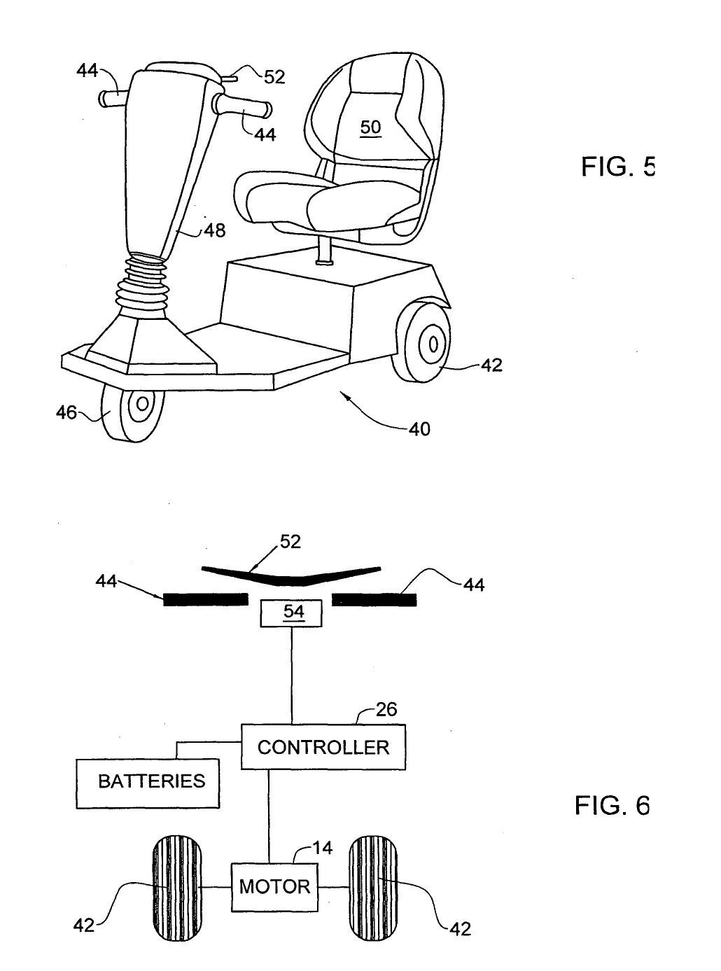

With reference to FIGS. 5 and 6, there is shown a three-wheeled scooter 40 using the control system of the present invention. A pair of rear wheels 42 is driven by a motor 14, and single front wheel 46 is manually steered by means of a tiller 48. The motor 14 drives wheels 42 through a differential (not shown), to allow the wheels to move at different speeds on curves.

The user sits on seat 50 and steers the vehicle 40 by means of handgrips 44 on the tiller 48. By turning the tiller 48, the user directly turns the front wheel 46. The user controls the speed by means of an actuator arm 52, which is pivotally mounted on the tiller 48 close to the handgrips 44. The actuator arm 52 operates a sensor 54, which detects which way, and how far, the actuator arm is moved. The further the actuator arm 52 is squeezed towards the handgrip 48, the faster the selected speed. The left-hand end of the actuator arm 52 is squeezed towards the adjacent handgrip 44 for forward movement, and the right-hand end for reverse movement. This arrangement may also be reversed or a single ended throttle may be used. The speed selected by the actuator arm 52 is conveyed to the controller 26, which controls the motor 14.

In the case of a three-wheeled vehicle, the tipping axis is not parallel to the motion direction as in FIG. 4. This can be accounted for by changing coefficients in the above formulae. Also, the forward acceleration will have a component in the lateral stability.

Electric vehicles using the control system of the present invention may also be driven by a motor driving the front wheels or a single front wheel, such as a 3-wheeled scooter in which the front wheel is driven by the motor. In this case, both drive and steering are applied to the front wheel.

The controller system and the method described above may also be applied to other types of electric vehicles where the steering is not performed directly by the user but indirectly, via the same controller system. A steering (turning) command may be sent by the user by means of electrical command units such as joystick or steering wheel whose position is measured by a sensor or by other means.

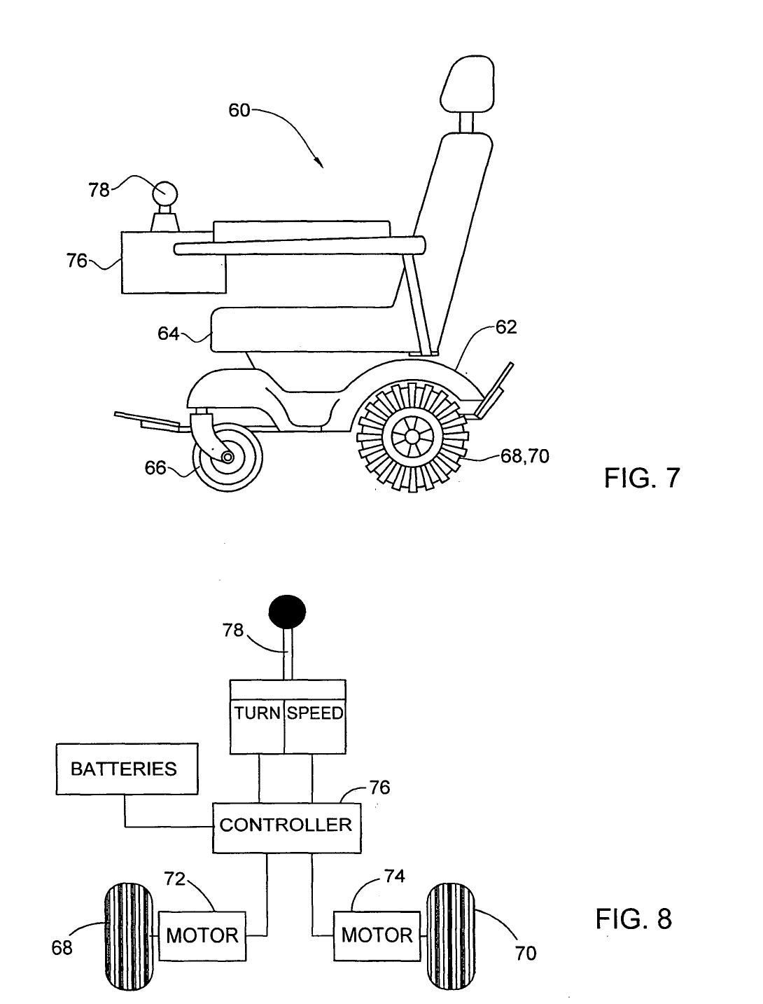

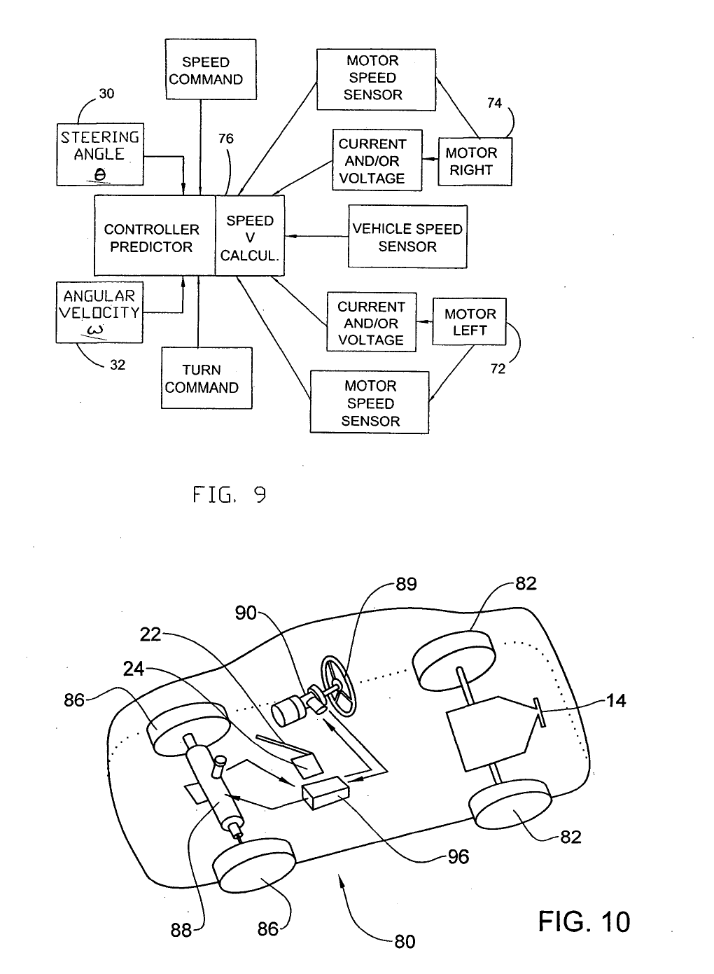

With reference to FIGS. 7, 8 and 9, there is shown a powered wheelchair 60 including a chassis 62, a seat 64, a freely swiveling castor assembly 66 and traction wheels 68, 70, driven by own electric drives 72, 74 respectively. The drives are controlled by a controller 76 implementing the method of the present invention, and having an operator command device 78. The command device 78 is shown in the form of a joystick but may be, among others, head movement sensor or a tiller sensor.

The operator command device 78 allows the operator to select velocity and turning commands and to send them to the controller 76 through electric cable or through wireless data transmission such as radio, ultra sonic, IR, etc. The command device 78 may be also an integral part of the controller 76. As in the previous examples, the control system of the wheelchair may have a sensor responsive to maneuvers, such as for example angular velocity sensor 32.

The controller 76 can control separately left and right electrical drives 72 and 74 to move each wheel 68, 70 separately forward, reverse or to stop. By controlling the left and right wheels to move each in different speed or even different direction, the controller 76 can make the powered wheelchair 60 move at the selected forward or backward velocity and at the selected turning angle.

The user sits on the seat 64 and provides speed and turning commands to the controller 76 by means of the command device 78.

Using the speed and turning commands, as well as measurements and calculations described above (but obtaining the speed of each wheel separately), the controller 76 “looks ahead” to predict the vehicle behavior. As above, if critical predicted condition is detected, the controller will override the user's commands. However, in this case the controller 76 may impose on the electric drives not only a “safety speed” but also a “safety turning angle” (or turning speed). This possibility to control both linear speed and turning angle may be used for optimizing the control, for example by imposing an additional condition such as substantially uniform deceleration.

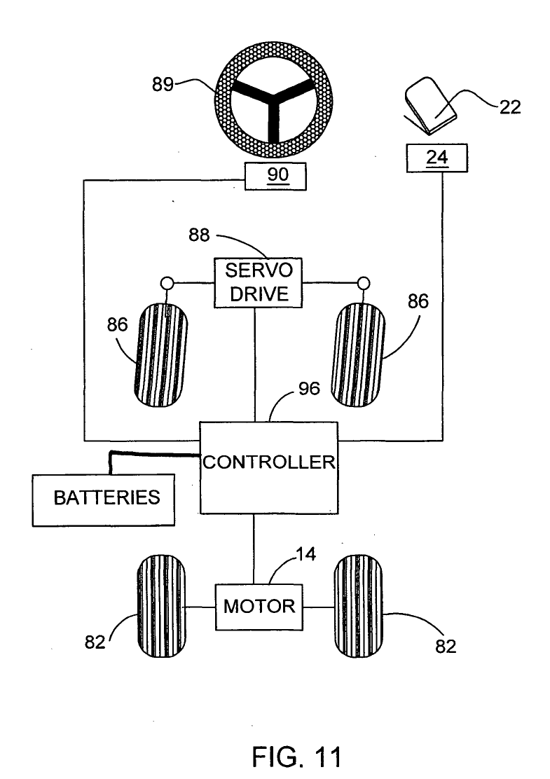

Another type of electric vehicles with electric steering is shown in FIGS. 10 and 11. A four-wheeled car 80 is an example of electric motor vehicle with electro-mechanical steering. The car 80 has a pair of rear wheels 82 driven by a motor drive 14 (shown in FIG. 11) and a pair of front wheels 86 that can be electrically steered by a servo drive 88. A mechanical steering wheel 89 with a steering wheel angle sensor 90 is connected to a controller 96 implementing the method of the present invention. Similarly to the vehicle in FIGS. 1 and 2, the vehicle 80 has a spring-loaded pedal 22 with a sensor 24 also connected to controller 96, for speed control.

The controller 96 controls the servo drive 88 and the motor drive 14 according to selected steering angle and selected speed commands provided by the user via the sensors 90 and 24 respectively. The method of safety control is implemented similarly to the example of the powered wheelchair 60.

In all versions of the controller, the user may be informed about the predicted critical condition or about overriding the speed or steering command by lighting a warning light, a voice signal or in another way. This will enable the user to change the command inputs to the controller. Also, a safety steering angle may be calculated in real time and operatively indicated (for example by an array of LEDs) for the user, in dependence of the current vehicle speed.

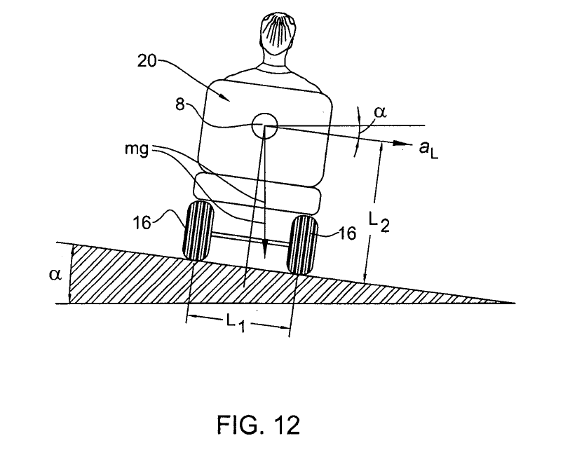

Although a description of specific embodiments has been presented, it is contemplated that various changes could be made without deviating from the scope of the present invention. For example, the system of the present invention may be simplified to work without including the linear velocity V in the control variables. Such system can use only measurements of lateral acceleration (in this case, the lateral acceleration is the stability criterion or is a factor that determines the stability criterion) and predict the lateral acceleration. With reference to FIG. 12, a critical predicted condition in such case is when the destabilizing moment M_{D} about the outer wheel is greater than the stabilizing moment of gravity M_{S}:

$${M}_{D} = m \cdot {a}_{L} {L}_{2} ; {M}_{S} = m \cdot g \cdot cos α \frac{{L}_{1}}{2} ; {M}_{D} > {M}_{S}$$

where

m—mass of vehicle and passenger operating at center of gravity;

g—gravity acceleration;

a_{L}—lateral acceleration;

α—lateral slope angle;

L₁—tread width;

L₂—center of gravity height above a horizontal terrain

What is claimed is:

1. A method of controlling a motorized vehicle comprising:
monitoring a movement characteristic and a stability criterion of a vehicle;
sensing a change in the movement characteristic of the vehicle; and
if the stability criterion and the change in the movement characteristic are above respective predefined values, causing a change in the velocity of the vehicle so that the stability criterion is no longer above the predefined value.

2. The method according to claim 1, wherein causing the change in the velocity of the vehicle so that the stability criterion is no longer above the predefined value comprises decreasing a magnitude of the velocity of the vehicle.

3. The method according to claim 1, wherein causing the change in the velocity of the vehicle so that the stability criterion is no longer above the predefined value comprises changing a direction of the vehicle.

4. The method according to claim 2, wherein the vehicle comprises an electrical propulsion system controlled by a computerized controller, and wherein decreasing the magnitude of the velocity comprises providing a vehicle speed command to said computerized controller for achieving a desired vehicle speed.

5. The method according to claim 3, wherein the vehicle comprises a steering system, and wherein changing the direction of the vehicle comprises providing a steering command at least indirectly to said steering system.

6. The method according to claim 1, further comprising:
periodically obtaining data which is characteristic of at least one of a maneuver of said vehicle and an external condition;
storing said data so that a set of current data and at least one set of past data are available;
calculating a predicted future stability condition of said vehicle using said current data and past data stored previously, and time-dependent equations of motion for said vehicle;
comparing said predicted condition to a predetermined safety criterion; and
if the predetermined safety criterion is not met, causing a change in the velocity of the vehicle so that the predetermined safety criterion is met.

7. The method according to claim 1, wherein the movement characteristic comprises velocity.

8. The method according to claim 1, wherein the movement characteristic comprises lateral acceleration.

9. The method according to claim 7, wherein the movement characteristic further comprises angular acceleration.

10. The method according to claim 6, wherein said data comprises at least one of a lateral slope angle of a terrain, a forward slope angle of the terrain, vehicle speed, and vehicle turning rate.

11. The method of according to claim 5, wherein said steering system is a mechanical steering system with operational status characterized by a steering parameter θ where said steering command is a change Δθ of said steering parameter θ.

12. A method of controlling a motorized vehicle comprising:
monitoring a movement characteristic and a stability criterion of a vehicle;
sensing a change in the movement characteristic of the vehicle; and
indicating to a rider of the vehicle if the stability criterion and the change in the movement characteristic are above respective predefined values, so that the rider can take action to stabilize the vehicle.

13. The method according to claim 12, wherein indicating to the rider comprises providing at least one of a visual signal, an audio signal and a vibration signal to the rider.
